(19) United States
(12) Patent Application Publication
(10) Pub. No.: US 2019/0095144 A1
(43) Pub. Date: Mar. 28, 2019

(54) SYSTEM AND METHOD FOR PRINT JOB STATUS COMMUNICATION

(71) Applicants: Kabushiki Kaisha Toshiba, Minato-ku (JP); Toshiba TEC Kabushiki Kaisha, Shinagawa-ku (JP)

(72) Inventor: Jonathan A. CHANNA, Rancho Cucamonga, CA (US)

(21) Appl. No.: 15/714,751

(22) Filed: Sep. 25, 2017

(51) Int. Cl. G06F 3/12

(52) U.S. Cl. CPC G06F 3/1207; G06F 3/1259; G06F 3/1288; G06F 3/126; G06F 3/1268; G06F 3/1294

(57) ABSTRACT

A system and method for printer communication with a designated device includes receiving an electronic document from a source device for printing as a print job. A print monitor monitors a status of the print job. A processor receives a status reporting instruction designating at least one designated device for print status reporting. A notice is sent informing each designated device that it has been designated to receive a status of the print job. Print job status is sent to each designated device via a network interface. Messaging between the printer and a designated device is done in an interactive, character inclusive protocol with the protocol corresponding to address information supplied for a designated device.

### TECHNICAL FIELD

This application relates generally to user notification of print job status. This application relates more particularly to designating one or more mobile devices for character based status updates relative to progress of large print jobs.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

Given the expense in obtaining and maintain MFPs, devices are frequently shared via a data network. MFPs, while moveable, are generally maintained in a fixed location. Users may send document processing jobs, such as a print request, to one or more networked devices. In a typical shared device setting, one or more workstations are connected via a network. When a user wants to print a document, an electronic copy of that document is sent to a document processing device via the network. The user may select a particular device when several are available. The user then walks to the selected device and picks up their job or waits for the printed document to be output. If multiple users send their requests to the same device, the jobs are queued and outputted sequentially. A user may also transfer a print job directly to an MFP via a portable memory device, such as a Universal Serial Bus (USB) drive, or from a user device by any suitable wired or wireless data connection.

When a user sends a print job via a network from their computer, they can receive notice of the print job status on the device from which the job was sent. In the case of a large print job, particularly in a shared MFP environment which may have jobs queued ahead, a user may have to make multiple trips to the MFP to see if their printout is complete. A user can also have an MFP notify them at their computer when their print job is complete so that they can walk to the MFP and pick it up.

### SUMMARY

In accordance with an example embodiment of the subject application, a system and method for printer communication with a designated device includes receiving an electronic document from a source device for printing as a print job. A print monitor monitors a status of the print job. A processor receives a status reporting instruction designating at least one designated device for print status reporting. A notice is sent informing each designated device that it has been designated to receive a status of the print job. Print job status is sent to each designated device via a network interface.

### BRIEF DESCRIPTION OF THE DRAWINGS

Various embodiments will become better understood with regard to the following description, appended claims and accompanying drawings wherein:

FIG. 1 an example embodiment of a system for print job information exchange;

FIG. 2 is an example embodiment of a multifunction peripheral;

FIG. 3 is an example embodiment of a digital device;

FIG. 4 is a flowchart of example operations for character inclusive dialog between a printer and a designated device; and

FIG. 5 is a ladder diagram of an example embodiment of communication between a printer, a server and a digital device.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

While it is useful to have print job status sent to a user while they are still at their workstation from which their job was sent, a user may not wish to remain at their workstation for the entire duration of a long print, particularly with print queue with many other, perhaps large print jobs ahead of theirs. Further delays could be attributed to MFP errors or depletion of consumables, such as toner, ink or paper. It could be many minutes, or even hours before their print job is complete. In accordance with example embodiments described herein, a user may send a print job to an MFP, along with instruction to facilitate communications relative to their print job to one or more alternative devices, including portable data devices such as the user's cell phone, tablet computer, smart watch, notebook computer or the like. A user may also designate an alternative workstation to receive their status messages. Exchanges between the user and the MFP are communicated by character inclusive messaging system, including text message or e-mail messaging, suitably in an interactive messaging format. Other suitable character inclusive communication systems may include message exchanges via social media or instant messaging. Examples include Facebook messaging, Twitter messaging, Snapchat messaging, and the like. Certain embodiments described herein are illustrative with texting or e-mailing, but it is contemplated that any suitable character inclusive system such as those noted above are included.

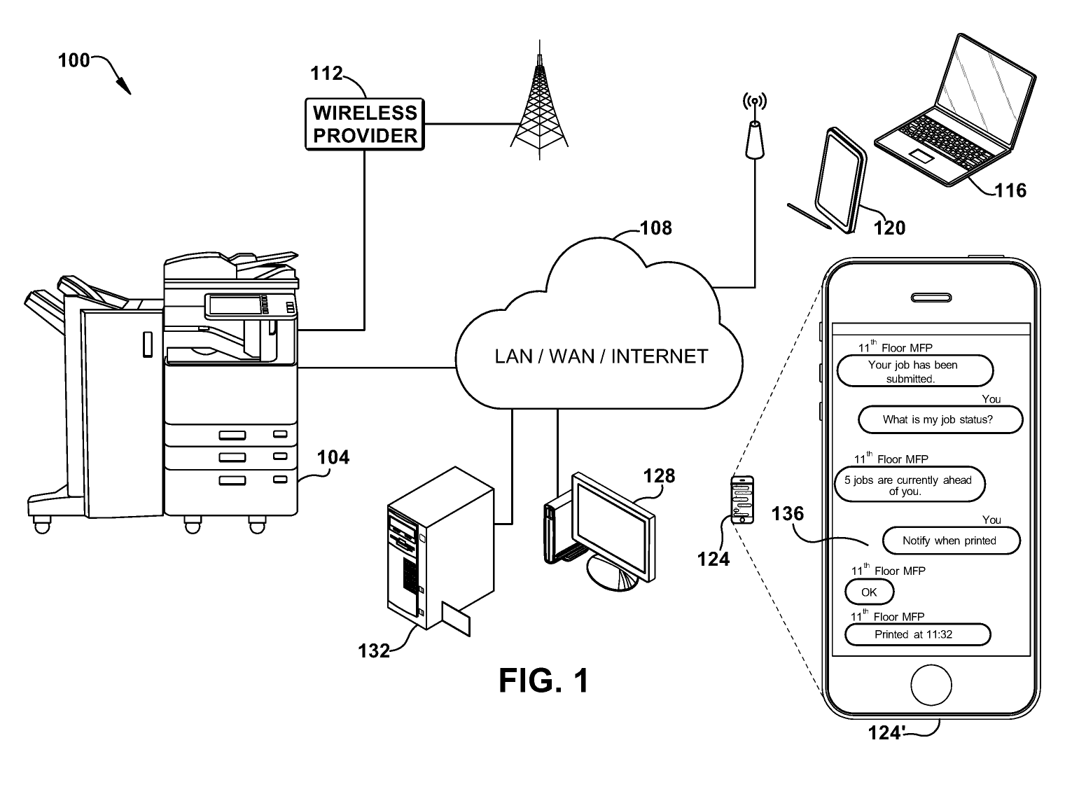

In accordance with the subject application, FIG. 1 illustrates an example embodiment of a print related information exchange system 100, such as a status data exchange, that includes one or more printing devices, such as MFP 104. MFP 104 is provided with a network interface for data exchange with a network 108 or a wireless provider 112, such as a cell phone service provider. Network 108 is suitably comprised of a local area network (LAN), or a wide area network (WAN) which may comprise the Internet. Also in wireless or wired data communication with network 108 are one or more user devices, such as notebook computer 116, tablet computer 120, smartphone 124, workstation 128 and one or more servers, such as server 132, suitably an e-mail server, print server, or both. When a print job is sent to MFP 104, a user designates one or more devices, such as smartphone 124, as a device for exchange of printer status or instructions. Each designated device includes address information for information exchange. Address information may be a network address, such as an Internet protocol address, a universal resource locator (URL), a smartphone phone number, an email address, a social media address, or the like. Each designated device is sent a message in a protocol corresponding to its address information to confirm that it has been designated. A device may return an instruction to have itself de-designated. Completion of a print job will automatically generate a status message that is sent to each designated device. Designated devices may also give status inquiries to which an updated status response is returned. A device may also direct that a print be aborted. Character based exchange facilitates a communication dialog such as that illustrated on touchscreen display 136 of smartphone 124′, which is a blow up rendering of smartphone 124.

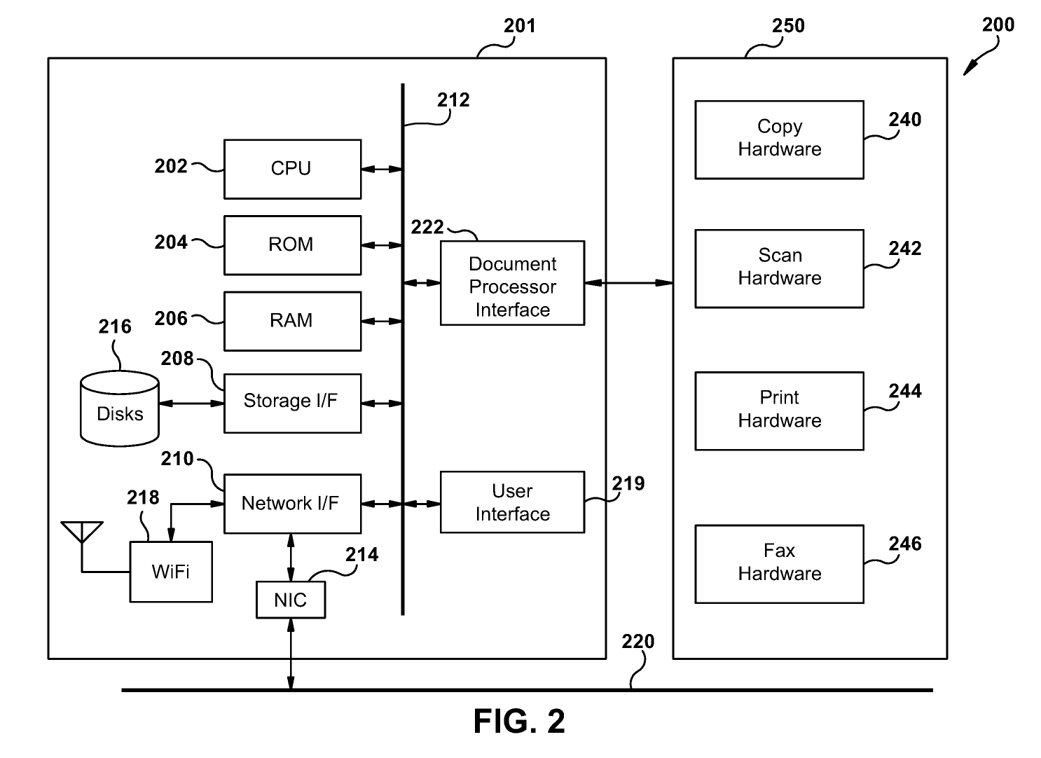

Turning now to FIG. 2 illustrated is an example embodiment of a networked digital device comprised of document rendering system 200 suitably comprised within an MFP, such as with MFP 132 of FIG. 1. It will be appreciated that an MFP includes an intelligent controller which is itself a computer system. Thus, and MFP can itself function as a cloud server with the capabilities descried herein. Included in controller 201 are one or more processors, such as that illustrated by processor 202. Each processor is suitably associated with non-volatile memory, such as ROM 204, and random access memory (RAM) 206, via a data bus 212.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired or physical network connection 220, or to a wireless data connection via wireless network interface 218. Example wireless connections include cellular, Wi-Fi, Bluetooth, NFC, wireless universal serial bus (wireless USB), satellite, and the like. Example wired interfaces include Ethernet, USB, IEEE 1394 (FireWire), Lightning, telephone line, or the like. Processor 202 is also in data communication with one or more sensors which provide data relative to a state of the device or associated surroundings, such as device temperature, ambient temperature, humidity, device movement and the like. Hardware monitors suitably provide device event data, working in concert with suitable monitoring systems. By way of further example, monitoring systems may include page counters, sensor output, such as consumable level sensors, temperature sensors, power quality sensors, device error sensors, door open sensors, and the like. Data is suitably stored in one or more device logs, such as in storage 216.

Processor 202 can also be in data communication with any suitable user input/output (I/O) interface 219 which provides data communication with user peripherals, such as displays, keyboards, mice, track balls, touch screens, or the like.

Also in data communication with data bus 212 is a document processor interface 222 suitable for data communication with MFP functional units 250. In the illustrate example, these units include copy hardware 240, scan hardware 242, print hardware 244 and fax hardware 246 which together comprise MFP functional hardware 250. It will be understood that functional units are suitably comprised of intelligent units, including any suitable hardware or software platform.

Controller 201 is suitably provided with an embedded web server system for device configuration and administration. A suitable web interface is comprised of TOPACCESS Controller (sometimes referred to in the subject illustrations as “TA”), available from Toshiba TEC Corporation.

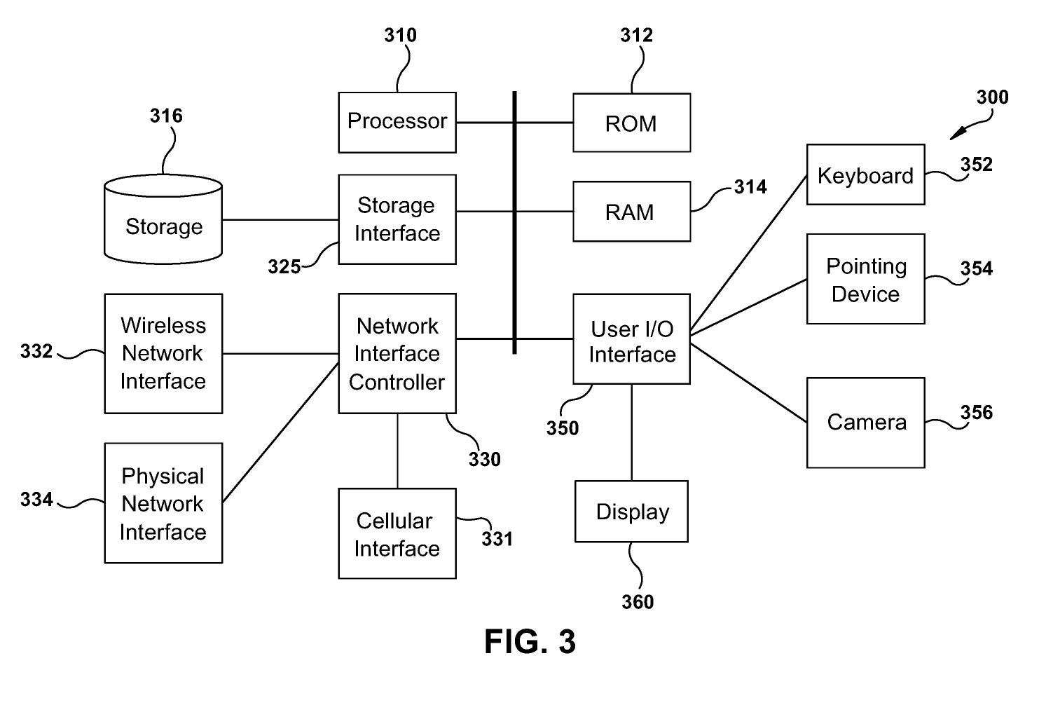

Turning now to FIG. 3, illustrated is an example embodiment of a digital data processing device 300, suitably comprising devices such as notebook computer 116, tablet computer 120, smartphone 124, workstation 128 and server 132 of FIG. 1. Components of the data processing device 300 suitably include one or more processors, illustrated by processor 310, memory, suitably comprised of read-only memory 312 and random access memory 314, and bulk or other non-volatile storage 316, suitable connected via a storage interface 325. A network interface controller 330 suitably provides a gateway for data communication with other devices via wireless network interface 332 and physical network interface 334, as well as a cellular interface 231 such as when the digital device is a cell phone or tablet computer. A user input/output interface 350 suitably provides a gateway to devices such as keyboard 352, pointing device 354, and display 260, suitably comprised of a touch-screen display. It will be understood that the computational platform to realize the system as detailed further below is suitably implemented on any or all of devices as described above. A camera 356 is suitably included such as when the digital device is a camera or tablet computer.

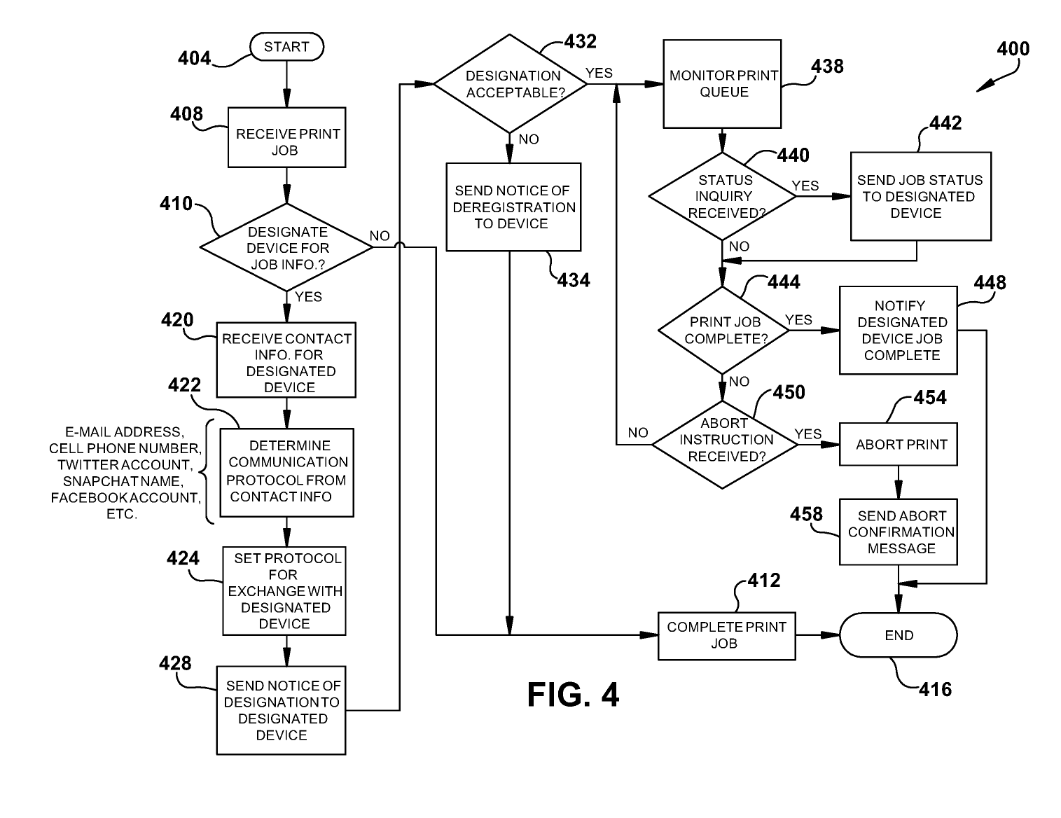

Referring next to FIG. 4, illustrated is a flowchart 400 for character inclusive dialog between a printer and one or more designated devices. The process commences at block 404 and a print job, which may include one or more electronic documents, is received at block 408. If no device for receiving status messages is designated at block 410, the print job is completed at block 412 and the process ends at block 416. Conventional dialog between a printer and a device sending the print job may still be maintained. If one or more devices are designated to receive status messages, then contact information is received for each such device at block 420, and a determination is made at block 422 as to how to communicate character information, such as text, to each designated device. A protocol for exchange with each designated device is set at block 424, and a notice of designation is sent to each device at block 428. Any device that responds that it is not to be designated at block 432 is deregistered. Notice of deregistration is sent at block 434, and the process moves to block 412 for printing before ending at block 416. For any device for which registration was accepted, or not refused, the process moves from block 432 to block 438 where a print queue associated with the job is monitored. If a status inquiry is received from a designated device at block 440, a current status is sent at block 442. Once status has been sent, or if no status was requested, a determination is made at block 444 as to whether the job is complete. If it is, each designated device is so notified at block 448 and the process ends at block 416. If the job is not yet complete, a determination as to whether an abort has been requested is made at block 450. If no abort instruction is received, the process returns to block 438. If an abort instruction is received, a confirmation message is sent at block 458 and the process ends at block 416.

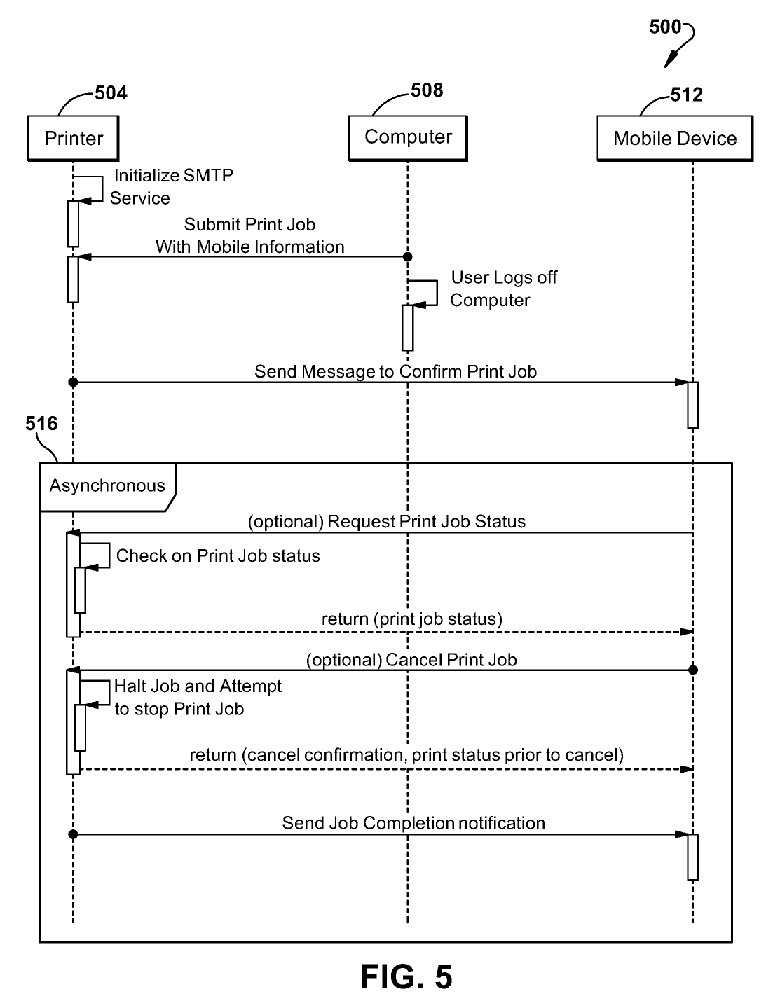

FIG. 5 illustrates a ladder diagram 500 of example operations detailing communication between a printer 504, one or more computers, such as computer 508 and one or more mobile devices, such as mobile device 512. For example, when a printer 504 boots up, the printer 504 initializes a SMTP (simple mail transfer protocol) service for receiving print jobs. A user on a computer 508 can then submit print jobs to the printer 504 which can include information about a designated mobile device 512 to receive print job status messages. At any time, the user can log off of the computer 508, as the remaining message exchanges take place between the printer 504 and the mobile device 512. Once the printer 504 has queued the user's print job, the printer 504 sends a print job confirmation status message to the mobile device 512. In the illustrated example, certain exchanges 516 are noted to be asynchronous as they are tied to user initiated sequences such as status requests or job aborts. For example, a user on the designated mobile device 512 can send a print job status inquiry to the printer 504 and receive a message that includes the current print job status. In another example, the user on the designated mobile device 512 can cancel the print job. The printer 504 then halts the print job and sends a cancel confirmation message to the designated mobile device which can include the print status on the printer 504 prior to halting the print job. Once the printer 504 has processed the user's print job, the printer 504 sends a suitable print job completion status message to the mobile device 512.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A device comprising:
an input configured to receive an electronic document from a source device for printing as a print job;
a network interface;
a print monitor configured to monitor a status of the print job; and
a processor and associated memory,
the processor configured to receive a status reporting instruction designating at least one designated device for print status reporting,
the processor configured to communicate a notice to the at least one designated device that the at least one designated device has been designated to receive a status of the print job, and
the processor configured to communicate the print job status to the at least one designated device via the network interface.

2. The device of claim 1 wherein the processor is further configured to communicate the print job status to the at least one designated device responsive to a print job status query received from the at least one designated device.

3. The device of claim 1 wherein the processor is further configured to abort the print job responsive to a command received from the at least one designated device via the network interface.

4. The device of claim 1 wherein the processor is further configured to communicate the print job status as a job completion notice when a completed print job is determined by the print monitor.

5. The device of claim 4 wherein the network interface is configured for data exchange corresponding to the print job status with a data network.

6. The device of claim 5 wherein the data network is comprised of a cellular phone system.

7. The device of claim 4 wherein the network interface is configured for data exchange with an associated e-mail server.

8. A method comprising:
receiving an electronic document from a source device for printing as a print job into a device having a processor and associated memory;
monitoring a status of the print job;
receiving a status reporting instruction designating at least one designated device for print status reporting;
communicating a notice to the at least one designated device that the at least one designated device has been designated to receive a status of the print job; and
communicating the print job status to the at least one designated device via the network interface.

9. The method of claim 8 further comprising communicating the print job status to the at least one designated device responsive to a print job status query received from the at least one designated device.

10. The method of claim 8 further comprising aborting the print job responsive to a cancel print job command received from the at least one designated device via the network interface.

11. The method of claim 8 further comprising communicating the print job status as a job completion notice when a completed print job is determined by the print monitor.

12. The method of claim 8 further comprising exchanging print job status data with a data network via a network interface.

13. The method of claim 12 wherein the data network is comprised of a cellular phone system.

14. The method of claim 8 further comprising exchanging print job status data with an associated e-mail server.

15. A device comprising:
a network interface;
a user interface including a display; and
a processor and associated memory configured for exchange of character based messages with a networked printing system via the network interface,
the processor further configured to receive, via the network interface, a notification that the device has been designated to receive a print job status,
the processor further configured to render the notification on the display,
the processor further configured to receive the print job status, and
the processor further configured to render the print job status on the display.

16. The device of claim 15 wherein:
the network interface is configured for data communication with an associated e-mail server, and
the character based messages are comprised of e-mail messages.

17. The device of claim 15 wherein:
the network interface is configured for data communication with an associated cellular service provider, and
the character based message are comprised of text messages.

18. The device of claim 15 wherein:
the processor is further configured to receive a cancel print instruction via the user interface, and
the processor is further configure to send the cancel print instruction to the networked printing system via the network interface.

19. The device of claim 15 wherein:
the processor is further configured to receive a print status inquiry instruction via the user interface, and
the processor is further configure to send the print status inquiry instruction to the networked printing system via the network interface.

20. The device of claim 15 wherein:
the processor is further configured to receive a print reporting confirmation instruction via the user interface responsive to a rendering of the notification on the display; and
the processor is further configured to communicate the print reporting confirmation to the networked printing system via the network interface.
